(19) United States
(12) Patent Application Publication
(10) Pub. No.: US 2026/0141478 A1
(43) Pub. Date: May 21, 2026

(54) IMAGE CAPTURING APPARATUS THAT GENERATES WIDE ANGLE IMAGE USING PLURARITY OF IMAGES, METHOD OF CONTROLLING THE SAME, AND STORAGE MEDIUM

(71) Applicant: CANON KABUSHIKI KAISHA, Tokyo (JP)

(72) Inventor: RYO SHIOTA, Kanagawa (JP)

(21) Appl. No.: 19/384,679

(22) Filed: Nov. 10, 2025

(30) Foreign Application Priority Data
Nov. 21, 2024 (JP) 2024-202929

(51) Int. Cl. G06T 3/4038; H04N 23/698

(52) U.S. Cl. CPC G06T 3/4038; H04N 23/698

(57) ABSTRACT

An image capturing apparatus includes an image sensor configured to capture a plurality of RAW images for compositing a panoramic image, a setting unit configured to set an image capturing condition for capturing the plurality of RAW images, a determination unit configured to determine an area within each of the plurality of RAW images to be used for generating the composite panoramic image, and a composite unit configured to composite a plurality of the areas to generate the composite panoramic image, wherein the determination unit determines a width of the area based on the image capturing condition, and wherein, in a case where the width does not satisfy a predetermined condition, the setting unit changes the image capturing condition or the determination unit changes the width.

### BACKGROUND

### Field of the Technology

The present disclosure relates to an image capturing apparatus, and in particular, to an image capturing apparatus that extracts a part of each of a plurality of images and composites the extracted parts of images.

### Description of the Related Art

A method has been used in which still images are consecutively captured while an image capturing apparatus is panned, center parts of the consecutively captured images are extracted in strip shapes, and the extracted parts of images are composited to generate an image having a wide angle of view (hereinafter, referred to as panoramic image).

Japanese Patent Laid-Open No. 2021-185689 describes that, to generate the panoramic image, captured images are mapped onto a virtual cylinder and then composited. This processing is for reducing differences at image coupling portions when the plurality of images captured in panning image capturing are composited.

In a case where the captured images are mapped onto the virtual cylinder, deterioration of image quality may occur depending on the format of the images. For example, it is known that, in the case of a Bayer array that is common as image data in a RAW format read out from the image capturing apparatus, a phenomenon such as deterioration of resolution, increase in false color, and the like is likely to occur due to geometric deformation. For this reason, when panorama composite with geometric deformation using image data in the RAW format is performed, it is necessary to suppress deterioration of image quality.

### SUMMARY

The present disclosure is directed to an image capturing apparatus and a control method that suppress deterioration of image quality when acquired RAW images are panoramically composited in panoramic image capturing and that take usability of a photographer into consideration.

According to an aspect of the present disclosure, an image capturing apparatus includes an image sensor configured to capture a plurality of RAW images, at least one processor, and at least one memory coupled to the at least one processor storing instructions that, when executed by the at least one processor, cause the at least one processor to function as: a setting unit configured to set an image capturing condition for capturing the plurality of RAW images, a determination unit configured to determine an area within each of the plurality of RAW images to be used for generating a composite RAW image, and a composite unit configured to composite a plurality of the areas to generate the composite RAW image, wherein the determination unit determines a width of the area based on the image capturing condition, and wherein, in a case where the width does not satisfy a predetermined condition, the setting unit changes the image capturing condition or the determination unit changes the width.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a digital camera according to an embodiment of the present disclosure.

FIG. 2 is a flowchart illustrating panoramic image capturing according to the embodiment of the present disclosure.

FIG. 3 is a flowchart illustrating a method of determining various kinds of conditions during the panoramic image capturing according to the embodiment of the present disclosure.

FIG. 4 is a diagram illustrating a composite ratio in a panorama composite according to the embodiment of the present disclosure.

### DESCRIPTION OF THE EMBODIMENTS

An exemplary embodiment of the present disclosure is described below with reference to the accompanying drawings. In the drawings, the same members or elements are denoted by the same reference numerals, and repetitive description is omitted or simplified. Further, in the following description, an example in which a digital (still) camera is adopted as an image capturing apparatus is described. However, the image capturing apparatus may include an electronic apparatus such as a movie camera, a smartphone with a camera, a tablet computer with a camera, an onboard camera, or a network camera.

### First Embodiment

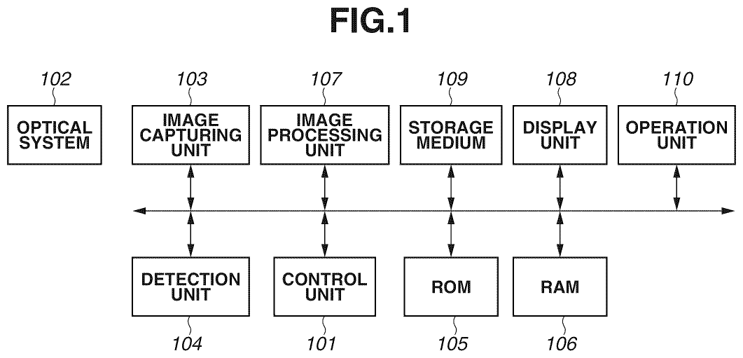

FIG. 1 is a block diagram illustrating an example of a configuration of a digital camera serving as an image capturing apparatus according to a first embodiment. A digital camera can consecutively capture still images and store data concerning the captured images. In the present embodiment, a description is given based on the premise that the consecutively captured still images are in a RAW format.

A control unit 101 is a processor, such as a central processing unit (CPU) or a microprocessor unit (MPU), and controls each of the units of the digital camera by reading out and executing various kinds of programs stored in a read-only memory (ROM) 105, described below. For example, as described below, the control unit 101 issues an image capturing start command and an image capturing end command to an image capturing unit 103, described below. Alternatively, the control unit 101 issues an image processing command to an image processing unit 107, described below, based on the programs stored in the ROM 105. A command from a user is input to the digital camera through an operation unit 110, described below, and reaches each of the units of the digital camera through the control unit 101.

An optical system 102 includes a lens, a diaphragm, a driving unit driving these optical members, and the like, and forms an image of light from an object on the image capturing unit 103. The image capturing unit 103 includes an image capturing element such as a charge coupled device (CCD) image sensor or a complementary metal-oxide semiconductor (CMOS) image sensor. The image capturing element performs photoelectric conversion on the optical image formed by the optical system 102 to form an analog image signal, thereby generating a captured image. The analog image signal is analog-to-digital (A/D) converted into digital image data by an A/D conversion unit of the image capturing unit 103. The converted digital image data is stored in a random-access memory (RAM) 106 through the image processing unit 107.

A detection unit 104 includes a gyroscope sensor and an acceleration sensor, and acquires angular velocity information, acceleration information, orientation information, and the like regarding the digital camera. The detection unit 104 can also detect vibration such as a shake or a swing of the digital camera.

The ROM 105 is a read-only nonvolatile memory serving as a recording medium, and stores operation programs of the units included in the digital camera, and parameters and the like necessary for operation of the units.

The RAM 106 is a rewritable volatile memory and is used as a temporary storage area for data output in operation of the units included in the digital camera. The RAM 106 has a storage capacity sufficient to store a predetermined number of still images, panoramic images (wide-angle images), and other images. The RAM 106 can also be used as a work area where programs and the like read out by the control unit 101 from the ROM 105.

The image processing unit 107 can perform various kinds of image processing such as white balance adjustment, color interpolation, reduction/magnification, or filtering, or composite processing on image data stored in the RAM 106 or recorded in a storage medium 109. Further, the image processing unit 107 performs compression processing and development processing on image data captured by the image capturing unit 103 according to a standard such as Joint Photographic Experts Group (JPEG).

The image processing unit 107 can perform panorama composite processing described below for compositing a plurality of images to generate a panoramic image. Further, the image processing unit 107 includes an image composite processing circuit that performs determination of a result of the panorama composite processing. In place of the configuration including the image processing unit 107, the function of the panorama composite processing may be realized by software processing of the control unit 101. For example, one or some or all of the functions equivalent to the image processing unit 107 may be performed based on the programs read out from the ROM 105 by the control unit 101.

A display unit 108 includes a display device such as a liquid crystal display (LCD) and performs through-image display and the like of the captured image acquired by the image capturing unit 103. Further, the display unit 108 displays image data temporarily stored in the RAM 106, image data stored in the storage medium 109 and a so-called graphical user interface such as a menu.

The operation unit 110 includes, for example, buttons, switches, keys, a mode dial of the digital camera, and a touch panel also serving as the display unit 108. A command from a user reaches the control unit 101 through the operation unit 110.

A RAW image according to the present embodiment is digital image data of an image captured by the image capturing unit 103 stored without being subjected to development processing and without the array of color components of the digital image data being changed. Accordingly, a RAW image cannot be directly displayed on the display unit 108. However, the user can select optional processing and perform development on the RAW image later because the RAW image is not subjected to compression processing and the like.

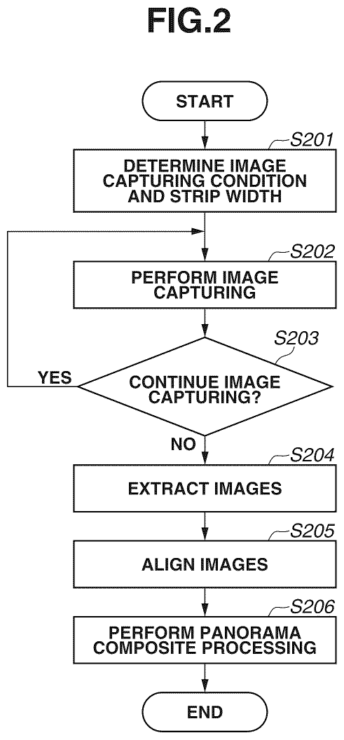

FIG. 2 is a flowchart illustrating panoramic image capturing according to the present embodiment. The processing illustrated in FIG. 2 starts when the user sets a mode of the digital camera to a panoramic image capturing mode. The mode can be set by, for example, operation of a mode setting dial corresponding to the operation unit 110, or operation of a menu displayed on the touch panel corresponding to the operation unit 110 and also serving as the display unit 108. Further, a mode setting button corresponding to the operation unit 110 may be provided on the digital camera, and the panoramic image capturing mode may be set in response to operation of the mode setting button.

As noted above, the present embodiment is described based on the premise that images of a Bayer array in a RAW format (RAW images) are acquired as input for a panorama composite in panoramic image capturing, and a panoramic image in a RAW format (composite RAW image) is generated from the plurality of RAW images. The data format of each image to be recorded may be selectable by the user in mode setting, and the user can select, for example, settings for recording data on the RAW image and data on the image in a JPEG format together.

In step S201, the control unit 101 determines a condition of panoramic image capturing. Details of a method of determining the condition are described below.

In step S202, the digital camera performs panoramic image capturing. For example, the image capturing is started when the user issues an image capturing instruction to the digital camera through the operation unit 110. The method of instructing the start of image capturing is not limited to this example. While the user pans the digital camera, the control unit 101 causes the image capturing unit 103 to perform image capturing based on the image capturing condition determined in step S201. The captured images are temporarily recorded in the RAM 106 and are used to generate a panoramic image later.

In step S203, the control unit 101 determines whether to continue or end the panoramic image capturing. For example, a method of determining the presence/absence of an image capturing end instruction through the operation unit 110, or a method of determining whether the size of the data to be recorded exceeds an upper limit value of the data capacity recordable in the RAM 106, may be used, but the method is not limited to these methods.

In a case where the panoramic image capturing ends as a result of the determination by the control unit 101 (NO in step S203), the processing proceeds to step S204. In a case where the panoramic image capturing continues as a result of the determination by the control unit 101 (YES in step S203), the processing proceeds to step S202.

In step S204, the image processing unit 107 extracts a strip-shaped RAW image for panorama composite from each of the RAW images acquired in step S202. A width determined as the condition of the panoramic image capturing in step S201 is used as the width of the strip-shaped RAW image to be extracted.

In step S205, the image processing unit 107 performs processing for aligning the strip-shaped RAW images extracted in step S204. The processing for aligning the strip-shaped RAW images is performed by calculating positional deviation amounts among the target strip-shaped RAW images and performing transformation.

An example of the method of calculating the positional deviation amount is described below. First, the image processing unit 107 sets a plurality of blocks to a reference strip-shaped RAW image. Each of the blocks set at this time has the same size. Next, the image processing unit 107 sets, in the strip-shaped RAW image to be aligned, a search range that is wider than the size of each of the blocks in the reference strip-shaped RAW image, at the same position as each of the blocks arranged in the reference strip-shaped RAW image. Finally, the image processing unit 107 calculates a correspondence point at which a sum of absolute difference (SAD) of luminance with the corresponding block of the reference strip-shaped RAW image becomes minimum, in the search range of the strip-shaped RAW image to be aligned. The image processing unit 107 calculates the positional deviation amount as a vector from a center of each of the blocks of the reference strip-shaped RAW image and the above-described correspondence point. In the calculation of the correspondence point described above, a sum of squared difference, normalized cross correlation, or the like may be used in addition to the SAD.

Next, the image processing unit 107 calculates a transformation coefficient from the positional deviation amount between the reference strip-shaped RAW image and the strip-shaped RAW image to be aligned. The image processing unit 107 uses, for example, a projective transformation coefficient as the transformation coefficient. However, the transformation coefficient is not limited only to the projective transformation coefficient, and an affine transformation coefficient or a simplified transformation coefficient for a horizontal/vertical shift may be used.

The image processing unit 107 performs geometric transformation on the target strip-shaped RAW image by using the calculated transformation coefficient. For example, the transformation can be performed using an expression (1).

$${I}^{′} = ( \begin{matrix}{x}^{′} \\ {y}^{′} \\ 1\end{matrix} ) = AI = ( \begin{matrix}a & b & c \\ d & e & f \\ g & h & i\end{matrix} ) ( \begin{matrix}x \\ y \\ 1\end{matrix} ) \qquad ( 1 )$$

In the expression (1), (x′, y′) indicates a coordinate after transformation, and (x, y) indicates a coordinate before transformation. A matrix A indicates the transformation coefficient.

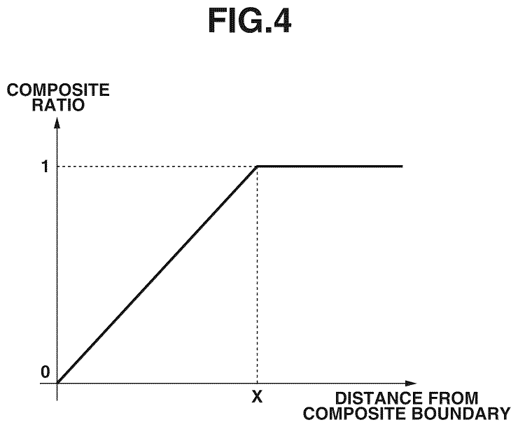

In step S206, the image processing unit 107 performs panorama composite processing of the strip-shaped RAW images. To make joints of the strip-shaped RAW images in the alignment processing in step S205 inconspicuous, the image processing unit 107 performs weighted average composite with a composite ratio curve as illustrated in FIG. 4, based on a distance from a predetermined composite boundary in a range where the strip-shaped RAW images overlap with each other. The composite method is not limited to this method, and a different method such as additive average composite may be used. The processing up to panorama composite processing is described above.

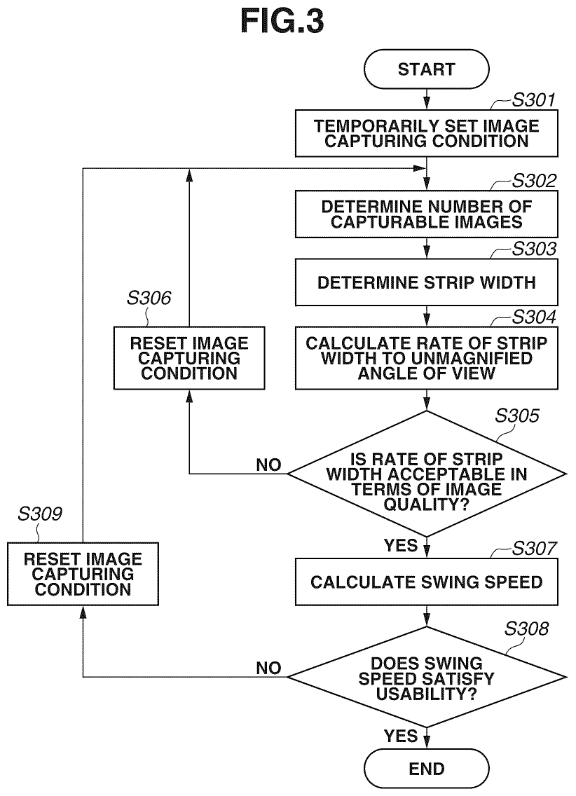

Subsequently, details of the method of determining the condition of the panoramic image capturing in step S201 are described with reference to the flowchart illustrated in FIG. 3.

In step S301, the control unit 101 temporarily sets an image capturing condition for the panoramic image capturing. The image capturing condition temporarily set at this time includes a target composite angle of view in panorama composite, and an image capturing frame rate during the panoramic image capturing. The image capturing condition temporarily set at this time also depends on the buffer capacity of the RAM 106, processing performance of the image processing unit 107 for panorama composite, an exposure condition of the digital camera in image capturing, and the like. The image capturing condition temporarily set is previously set inside each digital camera.

In the image capturing condition temporarily set, for example, an optional value can be used as the target composite angle of view. Preferably the target composite angle of view can be set such that it has a predetermined size or more. In other words, the target composite angle of view is set such that the panoramic image has the angle of view of a predetermined value or more and a size of the image. The processing performance of the image processing unit 107 for the panorama composite is determined by an algorithm of the panorama composite, and by engine performance of the control unit 101 and the image processing unit 107. Further, the image capturing frame rate may also be previously determined to be a value corresponding to the exposure condition (such as shutter speed).

In step S302, the control unit 101 determines the number of images that can be captured (number of capturable images) until the buffer of the RAM 106 prepared for panoramic image capturing becomes full, based on the image capturing condition temporarily set in step S301. The number of capturable images can be determined from the buffer capacity prepared in the RAM 106 for panoramic image capturing, a capacity necessary for recording one RAW image acquired during the panoramic image capturing, the image capturing frame rate, and the processing performance of the image processing unit 107. More specifically, the buffer capacity is denoted by Cbuffer [byte], the capacity necessary for recording one RAW image is denoted by Coneshot [byte/piece], the image capturing frame rate is denoted by Sshot [piece/sec], and the processing performance of the image processing unit 107 (number of processed images per unit time) is denoted by Sproc [piece/sec]. The number of capturable images Nfull [piece] at this time can be determined as follows:

$$Nfull = {Cbuffer}^{*} Sshot / ( {( Sshot - Sproc )}^{*} Coneshot ) . \qquad ( 2 )$$

The capacity necessary for recording one RAW image is actually varied during the panoramic image capturing. Accordingly, the capacity necessary for recording one RAW image may be determined, for example, by referring to the recording size of the data corresponding to the RAW image acquired by the image capturing unit 103 immediately before the panoramic image capturing start instruction. Alternatively, the capacity necessary for recording one RAW image may be a preset value because it is sufficient to roughly calculate the number of capturable images.

In step S303, the control unit 101 determines the width of the strip extracted from each of the RAW images acquired during the panoramic image capturing. The width of the strip to be extracted can be determined from, for example, the number of capturable images and the angle of view after composite. More specifically, when the angle of view after composite is denoted by Acomposite [deg], the width (angle of view) of one strip Astrip [deg/piece] can be determined as follows:

$$Astrip = Acomposite / Nfull . \qquad ( 3 )$$

The width (angle of view) of one strip determined by the expression (3) assumes that the number of capturable images corresponds to the number of images used for composite, but the panoramic image capturing may end before the number of images reaches the upper limit of the number of capturable images. The value is a roughly calculated value of the width (angle of view) of one strip in a temporary setting. In and after step S304, it is determined whether to use the value as it is in the subsequent panoramic image capturing.

In step S304, the control unit 101 determines the ratio of the width (angle of view) of one strip calculated in step S303 to the entire angle of view of one captured RAW image. When the entire angle of view of one RAW image is denoted by Afull [deg], a ratio Rstrip [%] of the width (angle of view) of one strip to the entire angle of view of one RAW image used for composite of the panoramic RAW image is determined as follows:

$$Rstrip = Astrip / Afull . \qquad ( 4 )$$

The entire angle of view Afull [deg] of one RAW image is a value depending on the focal length of the lens of the optical system 102 and the size of the sensor of the image capturing unit 103.

The entire angle of view Afull [deg] of one RAW image may also depend on the setting of a recorded image size, image processing, and the size of a readout area of the sensor, in place of the size of the sensor of the image capturing unit 103. For example, the size of the angle of view of one captured RAW image may be adjustable by the image processing unit 107. In this case, the image processing unit 107 extracts the RAW image read out from the image capturing element to have a predetermined size, and the angle of view of the extracted RAW image may be defined as Afull [deg].

In step S305, the control unit 101 determines whether the value of the ratio of strip width determined in step S304 is acceptable. More specifically, a threshold for the ratio of the strip width may be set, and in a case where the ratio of the strip width is within the threshold, the control unit 101 may determine that the current ratio of the strip width is acceptable. It is generally known that deterioration of image quality occurs due to geometric transformation and the like of the RAW image in panorama composite as the ratio of the strip width is larger. For this reason, an upper limit is set to the ratio of the strip width used for composite based on the angle of view of one RAW image.

Further, a lower limit may be set to the ratio of the strip width used for composite based on the angle of view of one RAW image. When the ratio of the strip width is reduced, deterioration of image quality caused by geometric transformation and the like of the RAW image in panorama composite is suppressed in theory. However, the relationship between the angle of view after composite (angle of view of panoramic RAW image) and the width (angle of view) of one strip is as described in the expression (3). When the ratio of the strip width is reduced, the number of RAW images necessary for composite is increased. In other words, the number of RAW images is limited by the capacity of the buffer that temporarily stores the RAW images necessary for composite. In addition, it takes more time to perform the composite processing as the number of images necessary for composite is increased, which leads to deterioration in usability. Accordingly, a lower limit may be set to the ratio of the strip width.

The thresholds (upper limit value and lower limit value) of the ratio of the strip width may be determined by, for example, experimentally examining the relationship between the ratio of the strip width and a deterioration degree of image quality.

In a case where the control unit 101 determines that the ratio of the strip width is acceptable (YES in step S305), the processing proceeds to step S307. Otherwise (NO in step S305), the processing proceeds to step S306.

In the present embodiment, the determination is performed based on the ratio of the width (angle of view) of one strip to the entire angle of view of one RAW image, but the determination may be performed based on the width (angle of view) of one strip. As described above, as the ratio of the strip width to the entire angle of view of the RAW image becomes larger, deterioration of image quality occurs due to geometric transformation and the like of the RAW image in panorama composite. This means that, in a case where the strip has a width greater than or equal to a predetermined size, deterioration of image quality occurs due to geometric transformation and the like of the RAW image. Accordingly, it may be determined in step S305 whether the width of the strip is acceptable based on the width of one strip determined in step S303.

In step S306, the control unit 101 resets the image capturing condition. To further reduce and settle the ratio of the strip width within the allowable range, for example, it is necessary to reduce the width (angle of view) of one strip Astrip [deg]. More specifically, the ratio of the strip width can be reduced by increasing the buffer capacity Cbuffer [byte] of the RAM 106 or reducing the difference between the image capturing frame rate and the processing speed of the image processing unit 107. After the control unit 101 resets the image capturing condition in this way, the processing proceeds to step S302.

In step S307, the control unit 101 calculates a swing speed during the panoramic image capturing. A swing speed Sswing [deg/sec] can be determined as follows:

$$Sswing = Acomposite / ( Nfull / Sshot ) . \qquad ( 5 )$$

The value corresponds to a panning speed recommended to the user during the panoramic image capturing.

In step S308, the control unit 101 determines whether the swing speed calculated in step S307 is within the range of a predetermined value. In the panoramic image capturing, the user generally performs image capturing while panning the digital camera. For this reason, the panoramic image capturing becomes difficult when the swing speed calculated in step S307, namely, the speed required for panning, is too high or too low. Accordingly, an upper limit value and a lower limit value are set for the swing speed required during the actual panoramic image capturing. For example, the upper limit value and the lower limit value of the swing speed can be experimentally determined and can be set based on the feeling experienced by a user during the actual panoramic image capturing.

The method of setting the upper limit value and the lower limit value is not limited to this method.

In a case where the control unit 101 determines that the swing speed calculated in step S307 is within the predetermined range (YES in step S308), the image capturing condition for the panoramic image capturing is fixed, and the processing ends. In contrast, in a case where the control unit 101 determines that the swing speed calculated in step S307 is not within the predetermined range (NO in step S308), the processing proceeds to step S309.

In step S309, the control unit 101 resets the image capturing condition. To increase the swing speed Sswing [deg/sec], it is necessary to increase the angle of view after composite Acomposite [deg] or the image capturing frame rate Sshot [piece/sec]. To reduce the swing speed Sswing [deg/sec], it is necessary to reduce the image capturing frame rate Sshot [piece/sec] or to increase the buffer capacity Cbuffer [byte]. After the condition is thus reset, the processing proceeds to step S302.

In the reset of the image capturing condition in step S309, the image capturing frame rate Sshot [piece/sec] can be increased by limiting the readout area of the image capturing element in the image capturing unit 103. By limiting the readout area of the image capturing element, image data can be generated from signals only in a partial area of the image capturing element of the image capturing unit 103. In this way, the readout area of the image capturing element of the image capturing unit 103 can be brought close to the size of the strip width necessary for composite. Readout from an area smaller than the entire area of the image capturing element (image sensor) is performed in the above-described manner, which makes it possible to improve the readout speed, and to increase the image capturing frame rate Sshot [piece/sec]. Note that such adjustment of the image capturing condition may be performed in steps S301 and S306 as necessary.

As described above, it is possible to present the suitable image capturing condition when the plurality of RAW images are captured and the panoramic RAW image is generated in the panoramic image capturing. This makes it possible to suppress deterioration of image quality when acquired RAW images are panoramically composited in panoramic image capturing, and to perform panoramic image capturing that takes the usability of a photographer into consideration.

### Other Embodiments

The present disclosure can be realized by supplying a program realizing one or more functions of the above-described embodiment to a system or an apparatus through a network or a recording medium, and causing one or more processors in a computer of the system or the apparatus to read out and execute the program. Further, the present disclosure can be realized by a circuit (e.g., application specific integrated circuit (ASIC)) realizing one or more functions. Further, the functions may be classified into the functions performed by the processor reading out the program and functions performed by a circuit, and the functions may be combined.

The present disclosure is not limited to the above-described embodiment, and can be variously modified and changed within the scope of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-202929, filed Nov. 21, 2024, the entirety of which is incorporated herein by reference.

What is claimed is:

1. An image capturing apparatus comprising:
an image sensor configured to capture a plurality of RAW images;
at least one processor; and
at least one memory coupled to the at least one processor storing instructions that, when executed by the at least one processor, cause the at least one processor to function as:
a setting unit configured to set an image capturing condition for capturing the plurality of RAW images;
a determination unit configured to determine an area within each of the plurality of RAW images to be used for generating a composite RAW image; and
a composite unit configured to composite a plurality of the areas to generate the composite RAW image,
wherein the determination unit determines a width of the area based on the image capturing condition, and
wherein, in a case where the width does not satisfy a predetermined condition, the setting unit changes the image capturing condition or the determination unit changes the width.

2. The image capturing apparatus according to claim 1, wherein the predetermined condition is a condition that the width is less than a first threshold.

3. The image capturing apparatus according to claim 1, wherein the predetermined condition is a condition that a ratio of the width to an angle of view corresponding to one of the plurality of RAW images is less than a first threshold.

4. The image capturing apparatus according to claim 1, wherein the setting unit sets the image capturing condition based on a processing speed of the composite unit.

5. The image capturing apparatus according to claim 1, wherein the composite unit composites the plurality of the areas by performing geometric transformation on the plurality of the areas.

6. The image capturing apparatus according to claim 1, wherein the plurality of RAW images captured by the image sensor are images of a Bayer array.

7. The image capturing apparatus according to claim 1, wherein the composite RAW image has an angle of view wider than an angle of view of each of the plurality of RAW images.

8. A method of controlling an image capturing apparatus, the method comprising:
setting an image capturing condition for capturing a plurality of RAW images;
capturing the plurality of RAW images;
determining an area within each of the plurality of RAW images to be used for generating a composite RAW image; and
compositing a plurality of the areas to generate the composite RAW image,
wherein a width of the area is determined based on the image capturing condition, and
wherein, in a case where the width does not satisfy a predetermined condition, the image capturing condition or the width is changed.

9. A non-transitory computer-readable storage medium storing a program that when executed on a computer causes the computer to perform a method of controlling an image capturing apparatus, the method comprising:
setting an image capturing condition for capturing a plurality of RAW images;
capturing the plurality of RAW images;
determining an area within each of the plurality of RAW images to be used for generating a composite RAW image; and
compositing a plurality of the areas to generate the composite RAW image,
wherein a width of the area is determined based on the image capturing condition, and
wherein, in a case where the width does not satisfy a predetermined condition, the image capturing condition or the width is changed.
